(19) United States
(12) Patent Application Publication
(10) Pub. No.: US 2025/0330204 A1
(43) Pub. Date: Oct. 23, 2025

(54) SEMICONDUCTOR DEVICE

(71) Applicant: Renesas Electronics Corporation, Tokyo (JP)

(72) Inventor: Kaoru KOHIRA, Tokyo (JP)

(21) Appl. No.: 19/075,922

(22) Filed: Mar. 11, 2025

(30) Foreign Application Priority Data
Apr. 22, 2024 (JP) 2024-069299

(51) Int. Cl. H04B 1/00

(52) U.S. Cl. CPC H04B 1/0092; H04B 1/0007

(57) ABSTRACT

A semiconductor device can enhance ranging accuracy while satisfying communication standards. The baseband circuit BBC, during transmission, divides the original pulse signal into multiple divided pulse signals so that each frequency bandwidth falls within the frequency bandwidth range specified by the UWB communication standard and overlaps a common frequency range, and sequentially transmits them to the receiving terminal via the analog front-end circuit AFE at a predetermined transmission interval. On the other hand, the baseband circuit BBC, during reception, inputs multiple divided pulse signals sequentially received with a predetermined time difference, corrects the time difference as if they were received simultaneously, and further corrects the phase of the multiple divided pulse signals to be continuous in the common frequency range. Then, the baseband circuit BBC restores the original pulse signal by synthesizing the corrected multiple divided pulse signals.

### CROSS-REFERENCE TO RELATED APPLICATIONS

The disclosure of Japanese Patent Application No. 2024-069299 filed on Apr. 22, 2024, including the specification, drawings and abstract is incorporated herein by reference in its entirety.

### BACKGROUND

The present invention relates to a semiconductor device, for example, a semiconductor device for wireless communication.

There are disclosed techniques listed below.

[Patent Document 1] Japanese Unexamined Patent Application Publication No. 2021-131307.

Patent Document 1 discloses a signal processing device for ultrasonic inspection that can appropriately measure the inspection target. The device first generates ultrasound by driving an ultrasonic probe using multiple burst wave signals of different frequencies and directs it at the inspection target. Subsequently, the device receives multiple reflected waves corresponding to each of the burst wave signals incident on the inspection target and performs detection processing on the received signals to obtain multiple detection signals.

### SUMMARY

For example, as distance measurement technology, techniques using Bluetooth (registered trademark) and the like have been known. On the other hand, in recent years, UWB (Ultra-Wide Band) technology, which utilizes frequency bandwidth, has attracted attention to achieve higher distance measurement accuracy. However, the radio frequency and frequency bandwidth are restricted by the UWB communication standard. As a result, it has been difficult to achieve higher distance measurement accuracy with conventional UWB systems. Therefore, there is a demand for technology that achieves higher distance measurement accuracy in UWB systems without violating communication standards.

The embodiments described later have been made in view of such circumstances, and other problems and novel features will become apparent from the description and accompanying drawings of this specification.

A semiconductor device according to one embodiment is a device for UWB wireless communication that is implemented in a transmission terminal or a reception terminal different from the transmission terminal. The semiconductor device includes a baseband circuit, a reference oscillator circuit, a local oscillator circuit, and an analog front-end circuit. The baseband circuit includes a memory for storing a transmission program or a reception program and a processor for executing the transmission program or the reception program, and processes baseband signals. The reference oscillator circuit generates a reference oscillation signal. The local oscillator circuit generates a local signal using the reference oscillation signal. The analog front-end circuit performs frequency conversion from a baseband signal to a high-frequency signal or from a high-frequency signal to a baseband signal using the local signal.

Here, when the semiconductor device is implemented in a transmission terminal, the baseband circuit performs processing (a) and processing (b) based on the transmission program, and when the semiconductor device is implemented in a reception terminal, it performs processing (c), processing (d), and processing (e) based on the reception program. In processing (a), the baseband circuit divides the original pulse signal, which becomes the baseband signal, into multiple divided pulse signals including a first divided pulse signal and a second divided pulse signal, so that each frequency bandwidth is within the range of the frequency bandwidth specified by the UWB communication standard and overlaps a common frequency range that is part of the frequency bandwidth. In processing (b), the baseband circuit sequentially transmits the multiple divided pulse signals to the reception terminal at a first transmission interval via the analog front-end circuit.

On the other hand, in processing (c), the baseband circuit inputs the multiple divided pulse signals sequentially received with a time difference based on the first transmission interval via the analog front-end circuit and corrects the time difference of the multiple divided pulse signals as if they were received simultaneously. In processing (d), the baseband circuit corrects the phase of the multiple divided pulse signals so that they are continuous in the common frequency range. In processing (e), the baseband circuit restores the original pulse signal by adding the multiple divided pulse signals after performing the time difference correction in processing (c) and the phase correction in processing (d).

According to the embodiment, the distance measurement accuracy can be enhanced while satisfying the communication standard.

### BRIEF DESCRIPTION OF THE DRAWINGS

FIG. 1 is a block diagram illustrating a schematic configuration example of a semiconductor device according to one embodiment.

FIG. 2 is a schematic diagram illustrating an example of the processing content when the transmission circuit shown in FIG. 1 divides a pulse signal.

FIG. 3 is a schematic diagram illustrating an example of the processing content of time difference correction performed by the reception circuit shown in FIG. 1.

FIG. 4 is a schematic diagram illustrating an example of the processing content of phase correction performed by the reception circuit shown in FIG. 1.

FIG. 5 is a schematic diagram illustrating the operating principle when the reception circuit shown in FIG. 1 estimates the phase difference of two divided pulse signals.

FIG. 6 is a flowchart illustrating an example of the detailed processing content of the transmission circuit shown in FIG. 1.

FIG. 7 is a schematic diagram illustrating in more detail a part of the processing content shown in FIG. 6.

FIG. 8 is a schematic diagram illustrating in more detail a part of the processing content shown in FIG. 6.

FIG. 9 is a schematic diagram illustrating in more detail a part of the processing content shown in FIG. 6.

FIG. 10 is a flowchart illustrating an example of the detailed processing content of the reception circuit shown in FIG. 1.

FIG. 11 is a schematic diagram illustrating in more detail a part of the processing content shown in FIG. 10.

FIG. 12 is a schematic diagram illustrating in more detail a part of the processing content shown in FIG. 10.

FIG. 13 is a schematic diagram illustrating in more detail a part of the processing content shown in FIG. 10.

FIG. 14 is a schematic diagram illustrating an example of modified processing content of FIG. 2.

FIG. 15 is a schematic diagram illustrating an example of a distance measurement method using a UWB system.

FIG. 16A is a waveform diagram illustrating an example of a pulse signal used in a UWB system.

FIG. 16B is a diagram illustrating an example of the frequency characteristics of the pulse signal shown in FIG. 16A.

FIG. 17A is a schematic diagram illustrating an example of a method for dividing the frequency bandwidth of the original pulse signal during transmission in a UWB system.

FIG. 17B is a schematic diagram illustrating an example of a method for dividing the frequency bandwidth of the original pulse signal during transmission in a UWB system.

FIG. 18A is a schematic diagram illustrating an example of a method for restoring the original pulse signal from multiple divided pulse signals during reception in a UWB system.

FIG. 18B is a schematic diagram illustrating an example of a method for restoring the original pulse signal from multiple divided pulse signals during reception in a UWB system.

FIG. 19 is a schematic diagram illustrating an example of a problem when using a frequency bandwidth division method in a UWB system.

FIG. 20 is a schematic diagram illustrating another example of a problem when using a frequency bandwidth division method in a UWB system.

### DETAILED DESCRIPTION

In the following embodiments, for convenience, when necessary, the description may be divided into multiple sections or embodiments, but unless specifically stated otherwise, they are not unrelated to each other, and one is related to the other as a partial or complete modification, detail, supplementary explanation, etc. Also, in the following embodiments, when referring to the number of elements, etc. (including quantity, numerical values, amounts, ranges, etc.), unless specifically stated otherwise and unless it is clearly limited to a specific number in principle, it is not limited to that specific number and may be more or less than that specific number.

Furthermore, in the following embodiments, it goes without saying that the constituent elements (including element steps, etc.) are not necessarily essential unless specifically stated otherwise and unless they are considered to be clearly essential in principle. Similarly, in the following embodiments, when referring to the shapes, positional relationships, etc. of components, etc., unless specifically stated otherwise and unless it is considered to be clearly not the case in principle, it is assumed to include those that are substantially approximate or similar to those shapes, etc. The same applies to the above numerical values and ranges.

Hereinafter, embodiments of the present invention are described in detail with reference to the drawings. In all the drawings for explaining the embodiments, the same reference numerals are given to the same members in principle, and repeated explanations thereof are omitted.

### Configuration of Semiconductor Device

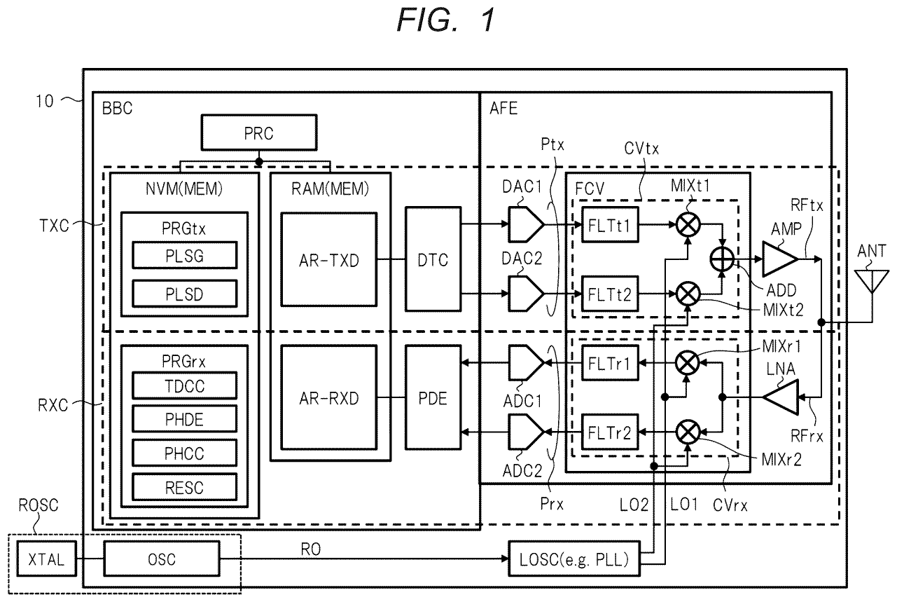

FIG. 1 is a block diagram illustrating a schematic configuration example of a semiconductor device 10 according to one embodiment. The semiconductor device 10 is a semiconductor device for UWB wireless communication that is implemented in a transmission terminal or a reception terminal different from the transmission terminal. For example, the semiconductor device 10 is an SoC (System on Chip) composed of a single semiconductor chip.

The semiconductor device 10 shown in FIG. 1 includes an oscillator circuit OSC, a local oscillator circuit LOSC, a baseband circuit BBC, and an analog front-end circuit AFE. The oscillator circuit OSC is connected to a crystal oscillator XTAL provided outside the semiconductor device 10. Thus, the oscillation circuit OSC and the crystal oscillator XTAL constitute a reference oscillation circuit ROSC, in other words, a crystal oscillation circuit that generates a reference oscillation signal RO. The semiconductor device 10, although not shown, operates based on a clock signal generated using the reference oscillation signal RO.

The local oscillation circuit LOSC uses the reference oscillation signal RO to generate local signals LO1 and LO2 that are synchronized with the reference oscillation signal RO. The local signals LO1 and LO2 have frequencies in the GHz order, such as 10 GHz, based on UWB communication standards, and are signals with a phase difference of 90 degrees from each other. The local oscillation circuit LOSC can be specifically configured using, for example, a PLL (Phase Locked Loop) circuit.

The baseband circuit BBC includes a processor PRC, a memory MEM, a data transfer circuit DTC, and a divided pulse signal extraction circuit PDE, and processes baseband signals. The processor PRC is, for example, a CPU (Central Processing Unit) or a DSP (Digital Signal Processor). The memory MEM includes non-volatile memory NVM and volatile memory RAM. The non-volatile memory NVM is, for example, MRAM (Magnetoresistive Random Access Memory) or flash memory. The volatile memory RAM is, for example, SRAM (Static RAM).

The non-volatile memory NVM stores a transmission program PRGtx and a reception program PRGrx. The processor PRC executes the transmission program PRGtx and the reception program PRGrx stored in MRAM or copied from flash memory to volatile memory RAM. By executing the transmission program PRGtx, the processor PRC functions as a pulse signal generation circuit PLSG and a pulse signal division circuit PLSD. In other words, the transmission program PRGtx enables the processor PRC to function as a pulse signal generation circuit PLSG and a pulse signal division circuit PLSD.

Additionally, by executing the reception program PRGrx, the processor PRC functions as a time difference correction circuit TDCC, a phase difference estimation circuit PHDE, a phase correction circuit PHCC, and a signal restoration circuit RESC. In other words, the reception program PRGrx enables the processor PRC to function as a time difference correction circuit TDCC, a phase difference estimation circuit PHDE, a phase correction circuit PHCC, and a signal restoration circuit RESC.

The volatile memory RAM has a transmission data storage area AR-TXD and a reception data storage area AR-RXD. Details will be described later, but the processor PRC generates a transmission digital signal based on the transmission program PRGtx. Then, the processor PRC stores the generated transmission digital signal in the transmission data storage area AR-TXD. The data transfer circuit DTC sequentially transfers the transmission digital signal stored in the transmission data storage area AR-TXD to the analog front-end circuit AFE. The data transfer circuit DTC can be implemented using a circuit similar to a DMA (Direct Memory Access) controller.

Additionally, as will be described in detail later, the divided pulse signal extraction circuit PDE stores the received digital signal from the analog front-end circuit AFE in the reception data storage area AR-RXD. The divided pulse signal extraction circuit PDE can also be implemented using a circuit similar to a DMA controller. The processor PRC processes the received digital signal stored in the reception data storage area AR-RXD based on the reception program PRGrx.

The analog front-end circuit AFE includes digital-to-analog converters DAC1 and DAC2, analog-to-digital converters ADC1 and ADC2, a frequency conversion circuit FCV, a transmission amplifier AMP, and a reception amplifier LNA. The digital-to-analog converters DAC1 and DAC2 convert the transmission digital signal stored in the transmission data storage area AR-TXD and input via the data transfer circuit DTC into a transmission analog signal. The transmission analog signal, and thus the transmission digital signal, is also a baseband signal, and in UWB, it becomes the transmission pulse signal Ptx.

The analog-to-digital converters ADC1 and ADC2 convert the received analog signal from the frequency conversion circuit FCV into a received digital signal. The received analog signal, and thus the received digital signal, is also a baseband signal, and in UWB, it becomes the received pulse signal Prx. Then, the analog-to-digital converters ADC1 and ADC2 store the converted received digital signal in the reception data storage area AR-RXD via the divided pulse signal extraction circuit PDE.

In this example, to perform quadrature modulation/demodulation (IQ modulation/IQ demodulation), a pair of digital-to-analog converters DAC1 and DAC2, and a pair of analog-to-digital converters ADC1 and ADC2 are provided. However, various circuit configurations are known for the analog front-end circuit AFE used in UWB, and it is not necessarily limited to the circuit configuration shown in FIG. 1.

The frequency conversion circuit FCV includes a transmission conversion circuit CVtx and a reception conversion circuit CVrx. The transmission conversion circuit CVtx has filters FLTt1 and FLTt2, mixers MIXt1 and MIXt2, and an adder ADD. The reception conversion circuit CVrx has filters FLTr1 and FLTr2, and mixers MIXr1 and MIXr2.

In the transmission conversion circuit CVtx, the filters FLTt1 and FLTt2 filter the transmission analog signal, i.e., the transmission pulse signal Ptx, from the digital-to-analog converters DAC1 and DAC2. The mixers MIXt1 and MIXt2 multiply the filtered signal with the local signals LO1 and LO2 from the local oscillation circuit LOSC. The adder ADD adds the signals from the mixers MIXt1 and MIXt2.

With this configuration, the transmission conversion circuit CVtx performs frequency conversion from a baseband signal to a high-frequency signal, i.e., up-conversion, using the local signals LO1 and LO2 from the local oscillation circuit LOSC. Furthermore, in this example, the transmission conversion circuit CVtx inputs the I and Q signals constituting the transmission pulse signal Ptx from the digital-to-analog converters DAC1 and DAC2 and performs quadrature modulation using the local signals LO1 and LO2, which have a phase difference of 90 degrees.

On the other hand, in the reception conversion circuit CVrx, the mixers MIXr1 and MIXr2 multiply the high-frequency signal from the reception amplifier LNA with the local signals LO1 and LO2 from the local oscillation circuit LOSC. The filters FLTr1 and FLTr2 filter the signals from the mixers MIXr1 and MIXr2 and output them to the analog-to-digital converters ADC1 and ADC2.

With this configuration, the reception conversion circuit CVrx performs frequency conversion from a high-frequency signal to a baseband signal, i.e., down-conversion, using the local signals LO1 and LO2 from the local oscillation circuit LOSC. Furthermore, in this example, the reception conversion circuit CVrx inputs the high-frequency signal from the reception amplifier LNA and performs quadrature demodulation into I and Q signals using the local signals LO1 and LO2.

The transmission amplifier AMP amplifies the high-frequency signal from the transmission conversion circuit CVtx, specifically from the adder ADD. Then, the transmission amplifier AMP radiates the amplified high-frequency signal RFtx into the air via an antenna ANT provided outside the semiconductor device 10. On the other hand, the reception amplifier LNA, for example, a low-noise amplifier, amplifies the high-frequency signal RFrx received by the external antenna ANT and outputs the amplified high-frequency signal to the reception conversion circuit CVrx, specifically to the mixers MIXr1 and MIXr2.

The pulse signal generation circuit PLSG, pulse signal division circuit PLSD, transmission data storage area AR-TXD, data transfer circuit DTC, digital-to-analog converters DAC1 and DAC2, transmission conversion circuit CVtx, and transmission amplifier AMP constitute the transmission circuit TXC. On the other hand, the time difference correction circuit TDCC, phase difference estimation circuit PHDE, phase correction circuit PHCC, signal restoration circuit RESC, reception data storage area AR-RXD, analog-to-digital converters ADC1 and ADC2, reception conversion circuit CVrx, and reception amplifier LNA constitute the reception circuit RXC.

Additionally, in this example, the baseband circuit BBC is implemented through program processing using the processor PRC. However, the baseband circuit BBC is not limited to the processor PRC and may be implemented using, for example, an FPGA (Field Programmable Gate Array) or dedicated digital circuits. That is, the semiconductor device 10 shown in FIG. 1 may include an FPGA or dedicated digital circuits. Before explaining the details of the semiconductor device 10 shown in FIG. 1, various elemental technologies considered by the inventors as a premise of the embodiment will be described.

### Regarding the Distance Measurement Method

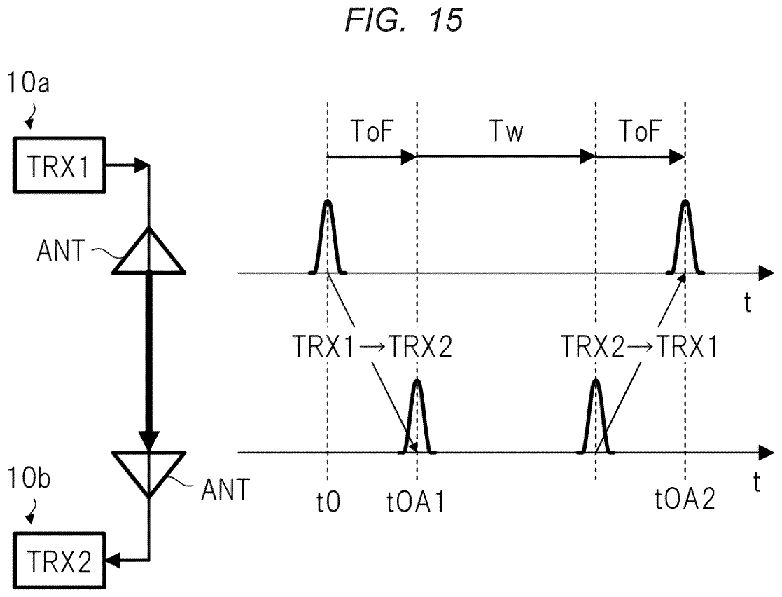

FIG. 15 is a schematic diagram illustrating an example of a distance measurement method using a UWB system. The UWB system shown in FIG. 15 includes two transceiver terminals TRX1 and TRX2. The two transceiver terminals TRX1 and TRX2 each implement semiconductor devices 10a and 10b as shown in FIG. 1.

In such a UWB system, first, the transceiver terminal TRX1 functions as a transmitting terminal and sends a pulse signal to the transceiver terminal TRX2 at timing t0. The transmitted pulse signal reaches the transceiver terminal TRX2 after a flight time ToF. The transceiver terminal TRX2 functions as a receiving terminal and estimates the arrival timing tOA1 of the pulse signal from the transceiver terminal TRX1. Then, the transceiver terminal TRX2 functions as a transmitting terminal and sends a pulse signal to the transceiver terminal TRX1 after waiting for a predetermined waiting time Tw from the estimated arrival timing tOA1.

The transmitted pulse signal reaches the transceiver terminal TRX1 after a flight time ToF. The transceiver terminal TRX1 functions as a receiving terminal and estimates the arrival timing tOA2 of the pulse signal from the transceiver terminal TRX2. Then, the transceiver terminal TRX1 calculates the flight time ToF from “2ToF+Tw”. That is, the transceiver terminal TRX1 can calculate the flight time ToF by subtracting the waiting time Tw from the time from timing t0 to arrival timing tOA2 and dividing the result by 2. Furthermore, the transceiver terminal TRX1 can also calculate the distance between the two transceiver terminals TRX1 and TRX2 based on the flight time ToF.

### Regarding Pulse Signals Based on UWB Standards

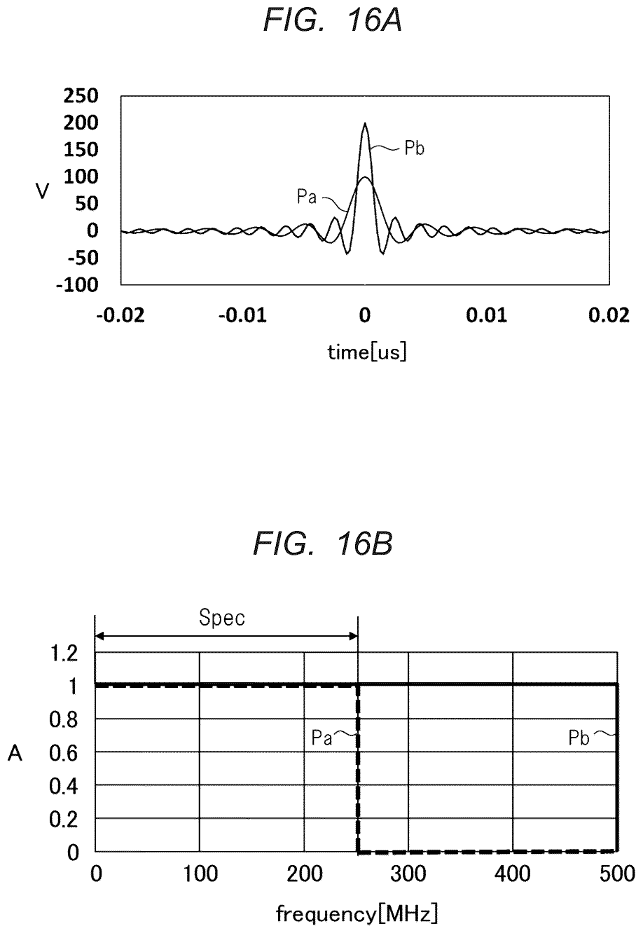

FIG. 16A is a waveform diagram showing an example of pulse signals Pa and Pb used in a UWB system. FIG. 16B is a diagram showing an example of the frequency characteristics of the pulse signals Pa and Pb shown in FIG. 16A. In a UWB system, as shown in FIG. 16A, pulse signals Pa and Pb with high peaks and narrow time widths are used. And by transmitting and receiving such pulse signals Pa and Pb between two terminals, distance measurement as described in FIG. 15 is performed.

Here, in distance measurement, the measurement error can increase as the time width of the pulse signals Pa and Pb increases. That is, the estimation error of the arrival timings tOA1 and tOA2 shown in FIG. 15 can become large. Therefore, to improve the accuracy of distance measurement, it is desirable to use pulse signals with sharper waveform shapes.

On the other hand, in such pulse signals, the sharper the waveform shape, that is, the higher the peak and the narrower the time width, the greater the frequency bandwidth. In the example shown in FIG. 16B, the frequency bandwidth of the pulse signal Pa is 250 MHz. In contrast, the frequency bandwidth of the pulse signal Pb with a sharper waveform shape is 500 MHz.

However, the allowable frequency bandwidth is usually limited to a predetermined value based on communication standards to avoid interference with other communication devices. For example, if the allowable frequency bandwidth is limited to 250 MHz, it may be difficult to perform distance measurement using the pulse signal Pb with a sharper waveform shape as it is. As a result, it may also be difficult to improve the accuracy of distance measurement.

### Regarding the Division of Frequency Bandwidth

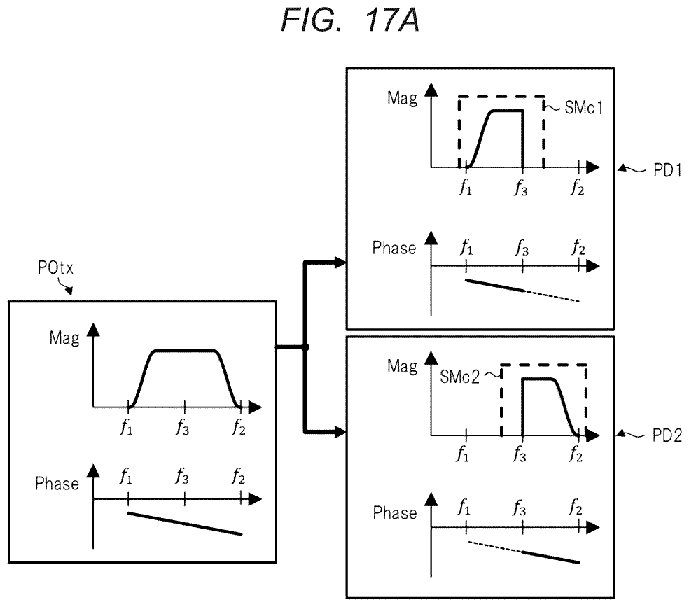

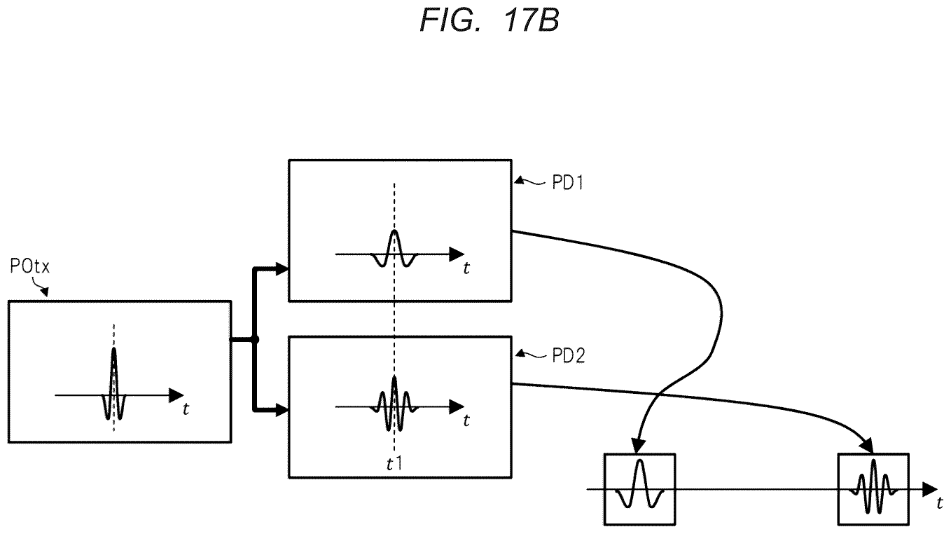

Therefore, a method of dividing the frequency bandwidth of pulse signals is considered. FIGS. 17A and 17B are schematic diagrams showing an example of a method for dividing the frequency bandwidth of the original pulse signal during transmission in a UWB system. FIG. 17A shows the amplitude (Mag) spectrum and phase (Phase) spectrum of the original pulse signal POtx used for transmission. The original pulse signal POtx has a frequency bandwidth from frequency f1 to frequency f2.

Also, FIG. 17A shows two or two-channel spectrum masks SMc1 and SMc2. Each spectrum mask SMc1 and SMc2 defines the allowable range based on communication standards for the frequency bandwidth and amplitude contained in the pulse signal. In this example, the spectrum mask SMc1 limits the pulse signal to a bandwidth from frequency f1 to frequency f3 (<f2). On the other hand, the spectrum mask SMc2 limits the pulse signal to a bandwidth from frequency f3 to frequency f2.

The semiconductor device 10 divides the original pulse signal POtx into two divided pulse signals PD1 and PD2, each having a different frequency bandwidth, using the two spectrum masks SMc1 and SMc2, so as to be within the frequency bandwidth range specified by the communication standards. Then, as shown in FIG. 17B, the semiconductor device 10 sequentially transmits the two divided pulse signals PD1 and PD2 with a time shift. As a result, the frequency bandwidth of the signal transmitted at one time can meet the communication standards.

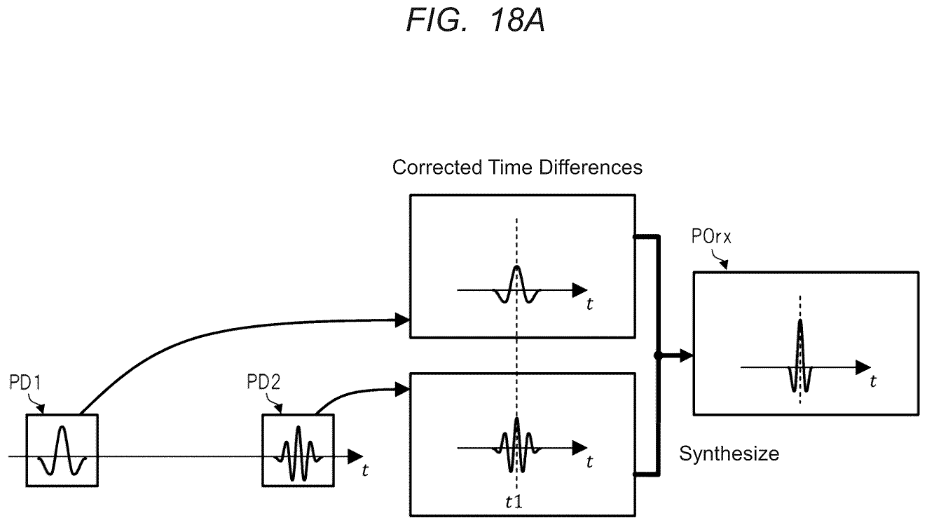

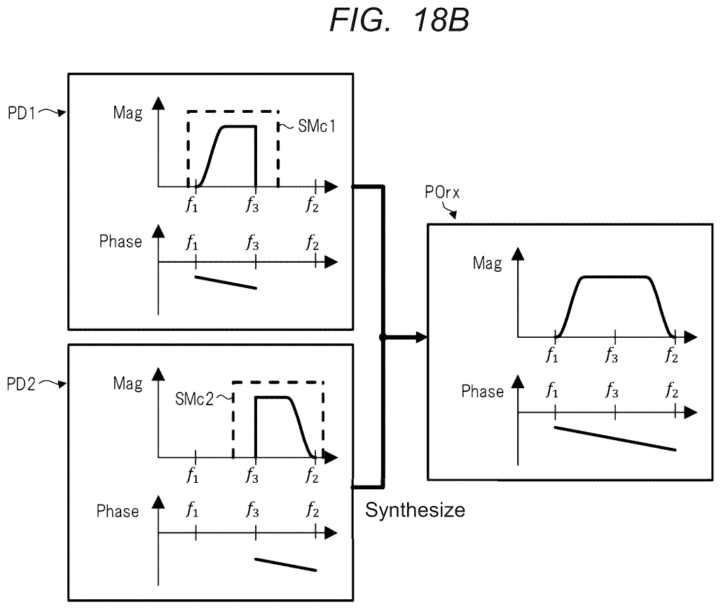

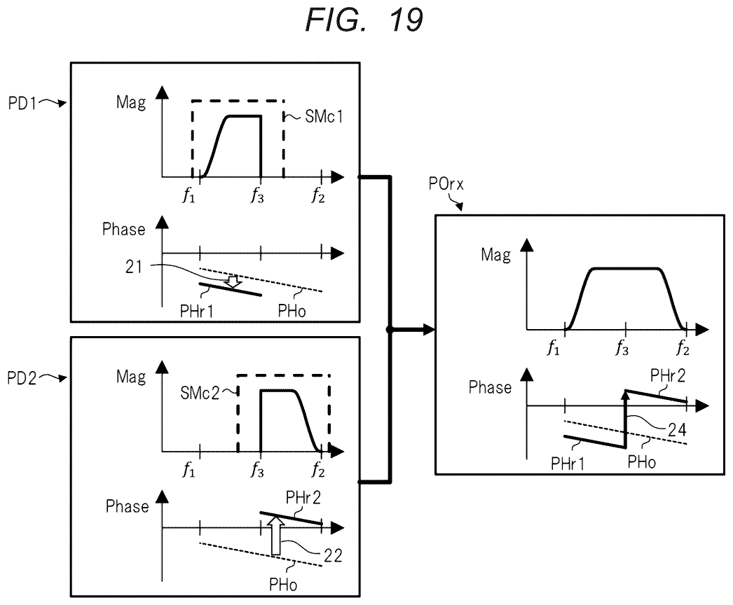

FIGS. 18A and 18B are schematic diagrams showing an example of a method for restoring the original pulse signal from multiple divided pulse signals PD1 and PD2 during reception in a UWB system. As shown in FIG. 18A, the semiconductor device 10 sequentially receives the multiple divided pulse signals PD1 and PD2 transmitted with a time shift and corrects the time difference to cancel the shifted time. That is, the semiconductor device 10 corrects the time difference of the multiple divided pulse signals PD1 and PD2 so that they are received simultaneously at timing t1.

Then, as shown in FIG. 18A, the semiconductor device 10 synthesizes, specifically adds, the signals with corrected time differences to restore the original pulse signal POrx. Ideally, the restored pulse signal POrx has the same waveform shape as the original pulse signal POtx at the time of transmission. That is, as shown in FIG. 18B, the amplitude spectrum and phase spectrum of the restored original pulse signal POrx are identical to the amplitude spectrum and phase spectrum of the original pulse signal POtx at the time of transmission shown in FIG. 17A.

### Regarding Issues with the Frequency Bandwidth Division Method

However, the frequency bandwidth division method described in FIGS. 17A, 17B, 18A, and 18B may cause the following issues. FIG. 19 is a schematic diagram showing an example of a problem when using the frequency bandwidth division method in a UWB system. As the first issue, as shown in FIG. 19, phase shifts 21 and 22 may occur in the divided pulse signals PD1 and PD2 received by the receiving terminal, based on the phase PHo of the original pulse signal POtx at the time of transmission.

The main cause of such phase shifts 21 and 22 is, for example, that the two transceiver terminals TRX1 and TRX2 shown in FIG. 15 do not share the reference oscillator circuit ROSC shown in FIG. 1. That is, the transceiver terminal TRX1 is connected to the crystal oscillator XTAL implemented in the transceiver terminal TRX1 and operates based on the vibration of the crystal oscillator XTAL. On the other hand, the transceiver terminal TRX2 is connected to another crystal oscillator XTAL implemented in the transceiver terminal TRX2 and operates based on the vibration of the crystal oscillator XTAL. As a result, the frequency and phase recognized by each of the two transceiver terminals TRX1 and TRX2 may strictly differ from each other.

When phase shifts 21 and 22 occur, a discontinuity point 24 occurs at the boundary between phase PHr1 of the divided pulse signal PD1 and the phase PHr2 of the divided pulse signal PD2 in the restored original pulse signal POrx. As a result, a pulse signal POrx with a waveform shape different from the original pulse signal POtx at the transmitting terminal may be restored at the receiving terminal. When a pulse signal POrx is different from the one at the time of transmission is restored in this way, the accuracy of distance measurement as described in FIG. 15 may decrease based on the pulse signal POrx.

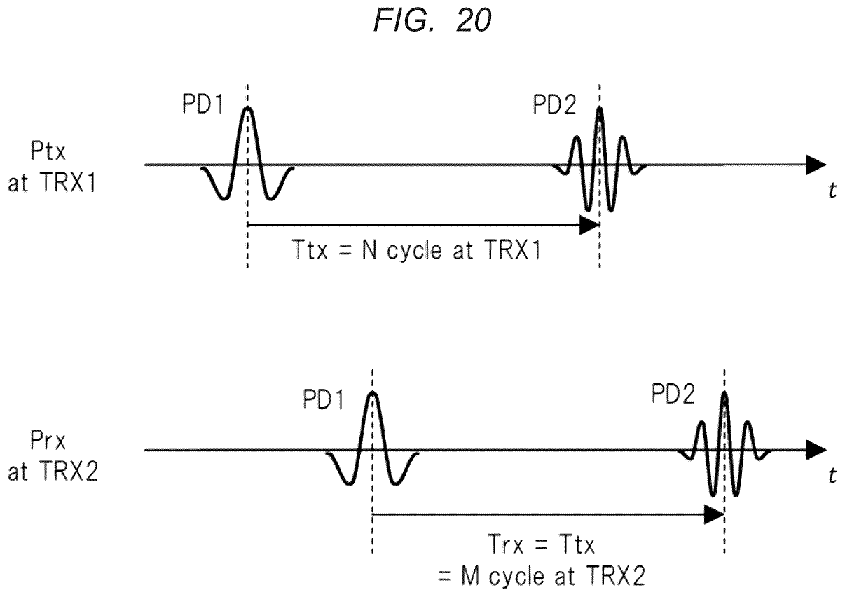

FIG. 20 is a schematic diagram showing another example of a problem when using the frequency bandwidth division method in a UWB system. As shown in FIG. 20, for example, with reference to the antenna ANT, the transmission interval Ttx of the two divided pulse signals PD1 and PD2 in the transceiver terminal TRX1 and the reception interval Trx of the two divided pulse signals PD1 and PD2 in the transceiver terminal TRX2 are of the same length.

Therefore, for example, the two transceiver terminals TRX1 and TRX2 may hold a common number of clock cycles “N” representing the transmission interval Ttx and the reception interval Trx in advance. As a result, the transceiver terminal TRX2 can align the two divided pulse signals PD1 and PD2 at the same timing t1, as shown in FIG. 18A, through internal processing based on the common number of clock cycles “N”.

However, in practice, the two transceiver terminals TRX1 and TRX2 do not share the reference oscillator circuit ROSC shown in FIG. 1. Therefore, as the second issue, as shown in FIG. 20, the number of clock cycles “N” in the transceiver terminal TRX1 representing the transmission interval Ttx and the reception interval Trx, and the number of clock cycles “M” in the transceiver terminal TRX2 may differ. As a result, in the method of defining a common number of clock cycles “N” as described above, it may be difficult to perform high-precision restoration processing. Therefore, it is beneficial to use the semiconductor device 10 shown in FIG. 1, particularly the baseband circuit BBC.

### Overview of the Main Parts of the Transmission Circuit

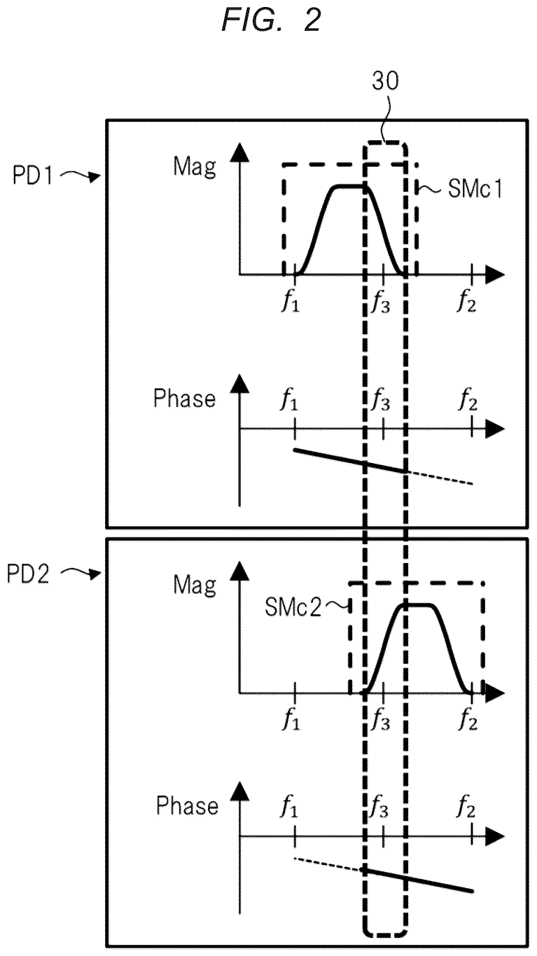

FIG. 2 is a schematic diagram illustrating an example of the processing content when the transmission circuit TXC shown in FIG. 1 divides a pulse signal. In FIG. 2, the transmission circuit TXC, similar to the case in FIG. 17A, divides the original pulse signal POtx, which has a frequency bandwidth from frequency f1 to frequency f2, into multiple, in this example, two divided pulse signals PD1 and PD2, so that each frequency bandwidth falls within the range specified by the UWB communication standard.

However, in this case, unlike the case in FIG. 17A, the transmission circuit TXC divides the original pulse signal POtx into two divided pulse signals PD1 and PD2, overlapping a common frequency range 30, which is part of the frequency bandwidth. Then, the transmission circuit TXC transmits the two divided pulse signals PD1 and PD2 sequentially at a predetermined transmission interval, similar to the case in FIG. 17B.

### Outline of the Main Part of the Receiving Circuit

On the other hand, the receiving circuit RXC first sequentially receives multiple, for example, two divided pulse signals PD1 and PD2, at a predetermined reception interval, i.e., a time difference based on the predetermined transmission interval, similar to the case in FIG. 18A. Then, the baseband circuit BBC within the receiving circuit RXC corrects the time difference of the two divided pulse signals PD1 and PD2, which are sequentially input via the analog front-end circuit AFE, as if they were received simultaneously. However, in this case, the baseband circuit BBC uses a method of calculating a correlation function, as described below, which is different from the method of determining a common clock cycle number “N” representing the transmission interval Ttx and the reception interval Trx, as mentioned in FIG. 20.

### Time Difference Correction

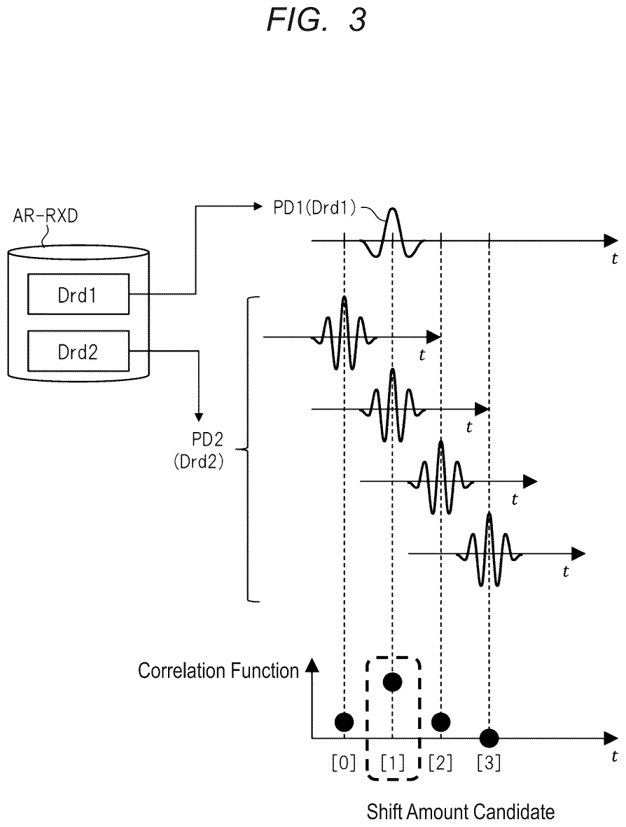

FIG. 3 is a schematic diagram illustrating an example of the processing content of time difference correction performed by the receiving circuit RXC shown in FIG. 1. First, the divided pulse signal extraction circuit PDE shown in FIG. 1 extracts the received digital signals Drd1 and Drd2 corresponding to the divided pulse signals PD1 and PD2, respectively, from the received digital signals from the analog-to-digital converters ADC1 and ADC2, based on the aforementioned common clock cycle number “N” time difference.

Then, as shown in FIG. 3, the divided pulse signal extraction circuit PDE stores the extracted received digital signals Drd1 and Drd2 in the reception data storage area AR-RXD. However, as mentioned in FIG. 20, the correct time difference between the two divided pulse signals PD1 and PD2 is not necessarily the common clock cycle number “N” and may be a number before or after it.

Therefore, the baseband circuit BBC within the receiving circuit RXC uses the received digital signals Drd1 and Drd2 stored in the reception data storage area AR-RXD to calculate the correlation function of the two divided pulse signals PD1 and PD2, as shown in FIG. 3, in the case where the reception timing of one of the divided pulse signals, here PD2, is shifted. Then, the baseband circuit BBC searches for the shift amount at which the correlation function, i.e., the similarity, of the two divided pulse signals PD1 and PD2 is maximized. Specifically, the baseband circuit BBC calculates the correlation function, i.e., the inner product, of the two divided pulse signals PD1 and PD2 based on equation (1). (Drd1, Drd2)=Σ(Drd1 (i) Drd2 (j) . . . (equation-1).

In equation-1, Drd1 (i) is the digital value of the divided pulse signal PD1 sampled at sampling timing (i). Drd2 (j) is the digital value of the divided pulse signal PD2 sampled at the shifted sampling timing (j). The baseband circuit BBC performs the operation shown in equation-1 to find the shift amount that maximizes the inner product and applies this shift amount to perform time difference correction to match the reception timing of the two divided pulse signals PD1 and PD2.

In the example shown in FIG. 3, when the reception timing is shifted for the divided pulse signal PD2 with the common clock cycle number “N” as the starting point, the inner product is maximized at shift amount candidate [1]. The baseband circuit BBC can match the reception timing of the two divided pulse signals PD1 and PD2 by applying this shift amount candidate [1] to correct the time difference.

### Regarding Phase Correction

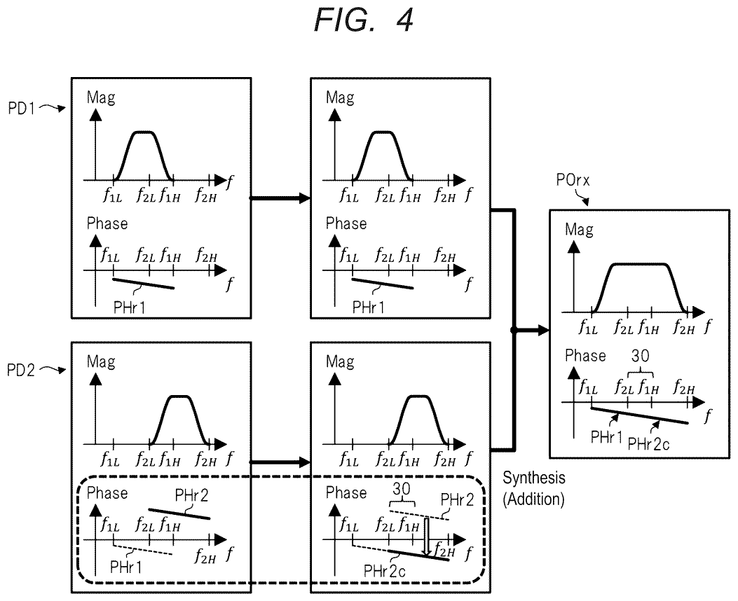

FIG. 4 is a schematic diagram illustrating an example of the processing content of phase correction performed by the receiving circuit RXC shown in FIG. 1. The baseband circuit BBC within the receiving circuit RXC corrects the phase of the two divided pulse signals PD1 and PD2 after time difference correction, as shown in FIG. 4, so that they are continuous in the common frequency range 30. Specifically, the baseband circuit BBC corrects the phase PHr2 of the divided pulse signal PD2 to phase PHr2c, so that it is continuous with the phase PHr1 of the divided pulse signal PD1 in the common frequency range 30, as shown in FIG. 4.

Then, the baseband circuit BBC synthesizes, specifically adds, the two divided pulse signals PD1 and PD2 after phase correction to restore the original pulse signal POrx. By performing such time difference correction and phase correction, the original pulse signal POrx restored at the time of reception will have the same waveform shape as the original pulse signal POtx at the time of transmission.

On the other hand, to perform phase correction as shown in FIG. 4, it is necessary to obtain the phase difference between phase PHr1 of the divided pulse signal PD1 and the phase PHr2 of the divided pulse signal PD2. One method of obtaining such a phase difference is to use Fourier transform, for example. However, using Fourier transform can result in a large amount of computation.

Therefore, the baseband circuit BBC multiplies the divided pulse signals PD1 and PD2 to obtain the phase difference and extracts the DC component from the multiplication result. That is, the baseband circuit BBC applies a low-pass filter to the multiplication result to remove the AC component. As a result, the baseband circuit BBC can estimate the phase difference between the phase PHr1 of the divided pulse signal PD1 and the phase PHr2 of the divided pulse signal PD2 with a small amount of computation.

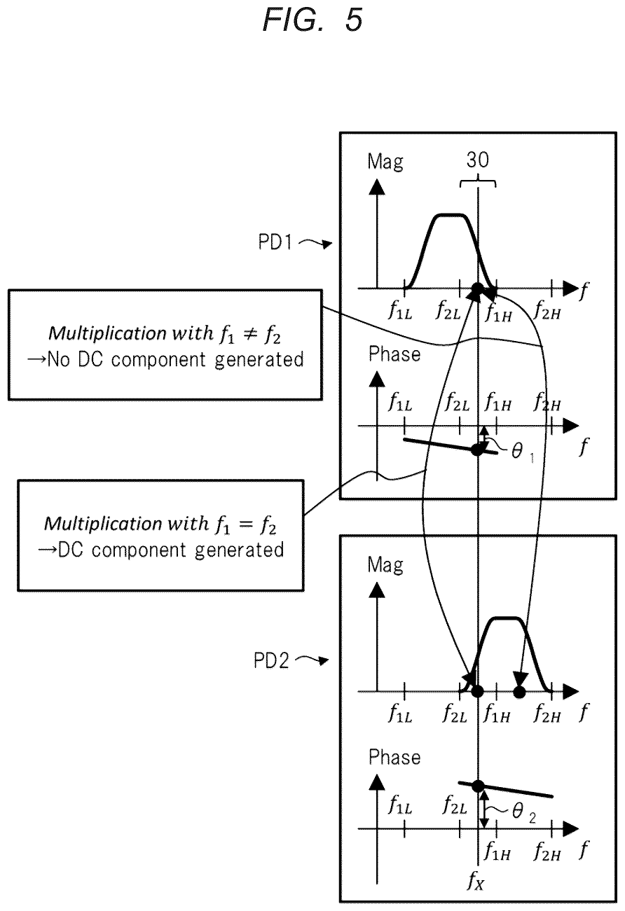

FIG. 5 is a schematic diagram illustrating the operating principle when the receiving circuit RXC shown in FIG. 1 estimates the phase difference between the two divided pulse signals PD1 and PD2. First, the multiplication result of the divided pulse signals PD1 and PD2 is given by equation-2. In equation-2, f1, θ1, and A1 are the frequency, phase, and amplitude of the divided pulse signal PD1, respectively. f2, θ2, and A2 are the frequency, phase, and amplitude of the divided pulse signal PD2, respectively. 2A1cos(2πf1t+θ1)A2cos(2πf2t+θ2) =A1A2cos{2π(f1+f2)t+(θ1+θ2)}+A1A2cos{2π(f1−f2)t+(θ1−θ2) } . . . (equation-2).

Here, in equation-2, if the frequency f1 and the frequency f2 are not matched, no DC component is generated. On the other hand, if the frequency f1 and the frequency f2 match, a DC component “A1A2cos (θ1−θ2)” is generated. Therefore, by applying a low-pass filter to the multiplication result, the DC component “A1A2cos (θ1−θ2)” is extracted.

The extracted DC component “A1A2cos (θ1−θ2)” represents the phase difference “θ1−θ2” at the matching frequency fX included in the common frequency range 30, as shown in FIG. 5. Therefore, the baseband circuit BBC can make the phase PHr1 of the divided pulse signal PD1 and the phase PHr2c of the divided pulse signal PD2 continuous in the common frequency range 30, as shown in FIG. 4, based on the phase difference “θ1−θ2” at the matching frequency fX.

### Detailed Operation of the Transmission Circuit TXC

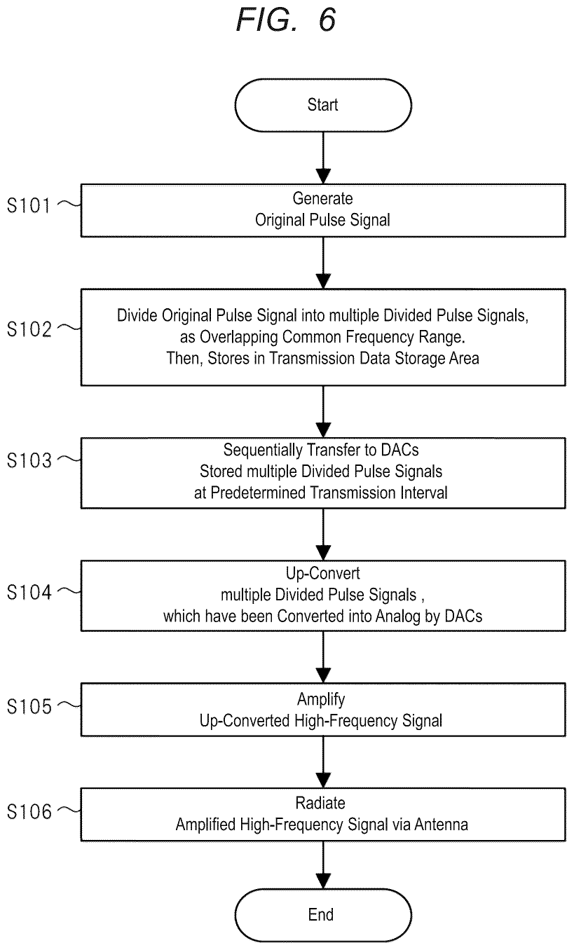

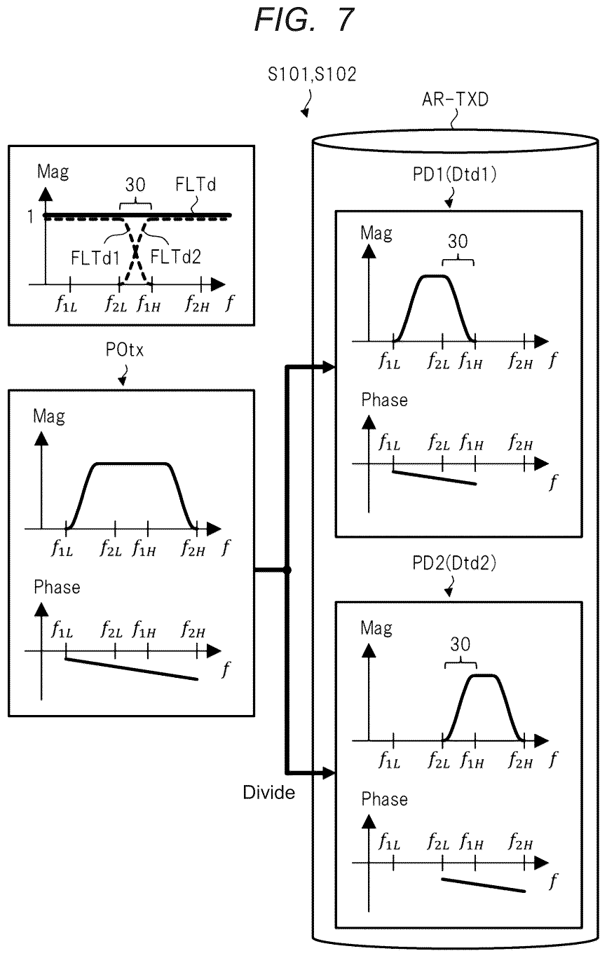

FIG. 6 is a flowchart illustrating an example of the detailed processing content of the transmission circuit TXC shown in FIG. 1. FIGS. 7, 8, and 9 are schematic diagrams that more specifically explain part of the processing content shown in FIG. 6. In FIG. 6, first, the pulse signal generation circuit PLSG generates the original pulse signal POtx (step S101). The original pulse signal POtx has a frequency bandwidth from frequency f1L to frequency f2H, as shown in FIG. 7.

Subsequently, in step S102, the pulse signal division circuit PLSD divides the original pulse signal POtx into multiple, for example, two divided pulse signals PD1 and PD2, so that each frequency bandwidth falls within the range specified by the UWB communication standard. At this time, the pulse signal division circuit PLSD divides the original pulse signal POtx into two divided pulse signals PD1 and PD2, overlapping the common frequency range 30. Then, the pulse signal division circuit PLSD stores the transmission digital signals Dtd1 and Dtd2 corresponding to the two divided pulse signals PD1 and PD2 in the transmission data storage area AR-TXD.

Specifically, in step S102, the pulse signal division circuit PLSD uses two filters FLTd1 and FLTd2, as shown in FIG. 7, to divide the original pulse signal POtx into two divided pulse signals PD1 and PD2. Filter FLTd1 has a passband from frequencies below frequency f1L to frequency f1H. On the other hand, filter FLTd2 has a passband from frequency f2L (<f1H) to frequencies above frequency f2H. The common frequency range 30 is the range from frequency f2L to frequency f1H.

The two filters FLTd1 and FLTd2 have frequency characteristics such that they have a predetermined gain value, in this example “1,” in the frequency band excluding the common frequency range 30. On the other hand, the two filters FLTd1 and FLTd2 have frequency characteristics such that the sum of the gain values of filter FLTd1 and filter FLTd2 results in a predetermined gain value of “1” within the common frequency range 30. That is, the combined filter FLTd of the two filters FLTd1 and FLTd2 has a predetermined gain value of “1” over the frequency bandwidth of the original pulse signal POtx.

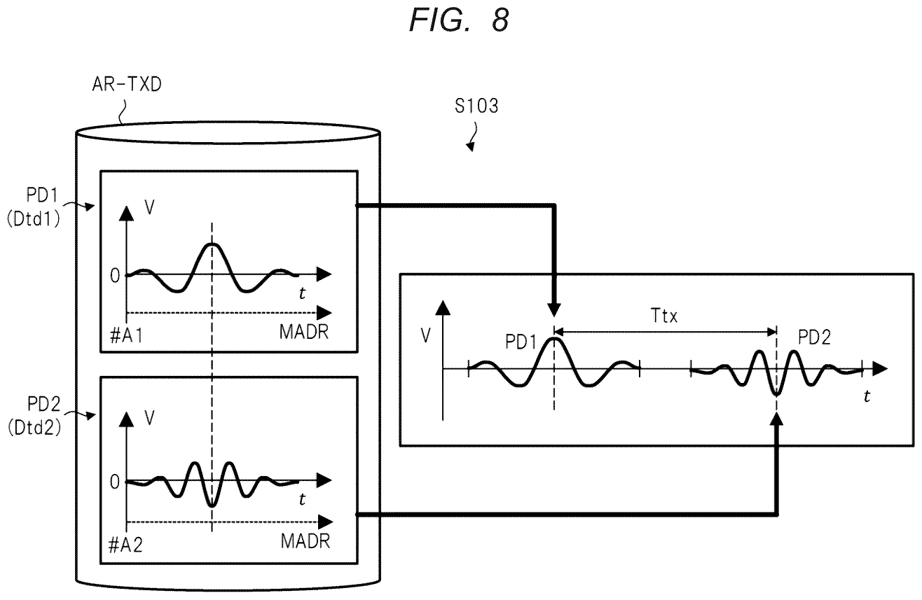

Next, in step S103 shown in FIG. 6, the data transfer circuit DTC sequentially transfers the two divided pulse signals PD1 and PD2, specifically the transmission digital signals Dtd1 and Dtd2 stored in the transmission data storage area AR-TXD, to the digital-to-analog converters DAC1 and DAC2 at a predetermined transmission interval Ttx. Specifically, as shown in FIG. 8, the transmission digital signals Dtd1 and Dtd2 are stored as time-series data in the memory address MADR area, which is sequentially allocated from f the predetermined starting addresses #A1 and #A2 in the transmission data storage area AR-TXD.

The data transfer circuit DTC sequentially reads out the transmission digital signal Dtd1 from the transmission data storage area AR-TXD at a transfer speed of, for example, several GHz, and then sequentially reads out the transmission digital signal Dtd2 after a predetermined transmission interval Ttx. The digital-to-analog converters DAC1 and DAC2 convert the sequentially read transmission digital signals Dtd1 and Dtd2 into analog signals at a sampling frequency of, for example, the same several GHz as the transfer speed.

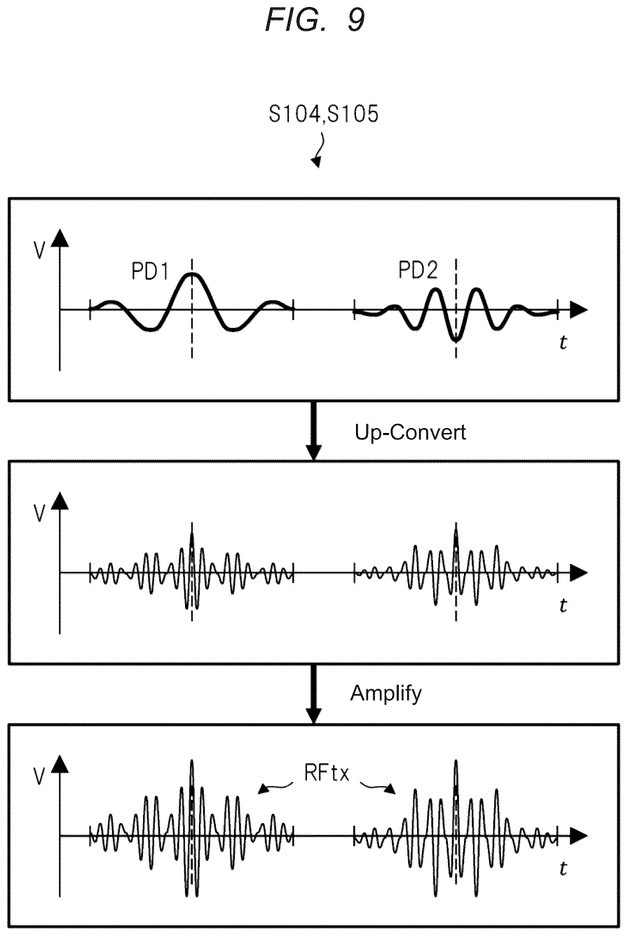

Subsequently, in step S104 shown in FIG. 6, the transmission conversion circuit CVtx up-converts the two divided pulse signals PD1 and PD2, which have been converted into analog signals by the digital-to-analog converters DAC1 and DAC2, into high-frequency signals using local signals LO1 and LO2, as shown in FIG. 9. Next, the transmission amplifier AMP amplifies the up-converted high-frequency signal as shown in FIG. 9 (step S105). Then, the transmission amplifier AMP radiates the amplified high-frequency signal RFtx into the air via an external antenna ANT (step S106).

### Detailed Operation of Reception Circuit RXC

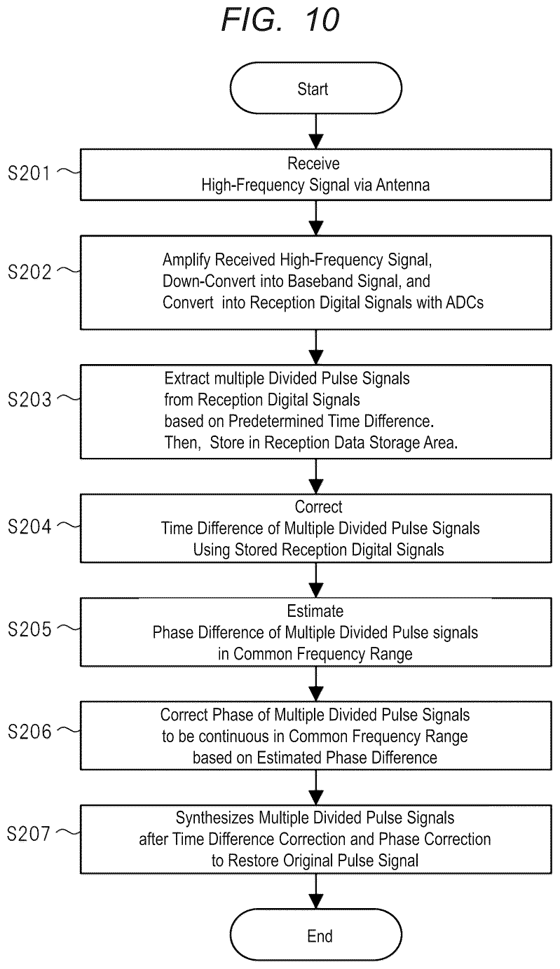

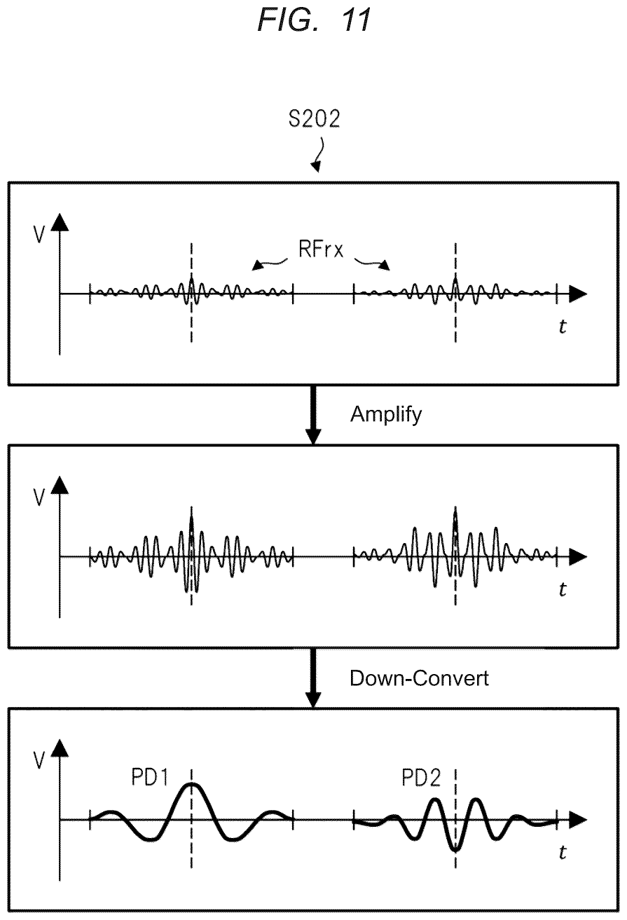

FIG. 10 is a flowchart showing an example of the detailed processing content of the reception circuit RXC shown in FIG. 1. FIGS. 11, 12, and 13 are schematic diagrams that more specifically explain part of the processing content shown in FIG. 10. In FIG. 10, first, the reception circuit RXC receives the high-frequency signal RFrx via an external antenna ANT (step S201).

Subsequently, in step S202, as shown in FIG. 11, the reception amplifier LNA amplifies the received high-frequency signal RFrx. Additionally, the reception conversion circuit CVrx down-converts the amplified high-frequency signal into a baseband signal. Then, the analog-to-digital converters ADC1 and ADC2 sequentially convert the down-converted signal into reception digital signals at a sampling frequency of, for example, several GHz.

Next, in step S203 shown in FIG. 10, the divided pulse signal extraction circuit PDE extracts the two divided pulse signals PD1 and PD2 from the reception digital signals from the analog-to-digital converters ADC1 and ADC2 based on a predetermined time difference. Then, the divided pulse signal extraction circuit PDE stores the extracted two divided pulse signals PD1 and PD2, specifically the reception digital signals Drd1 and Drd2 corresponding to the two divided pulse signals PD1 and PD2, in the reception data storage area AR-RXD.

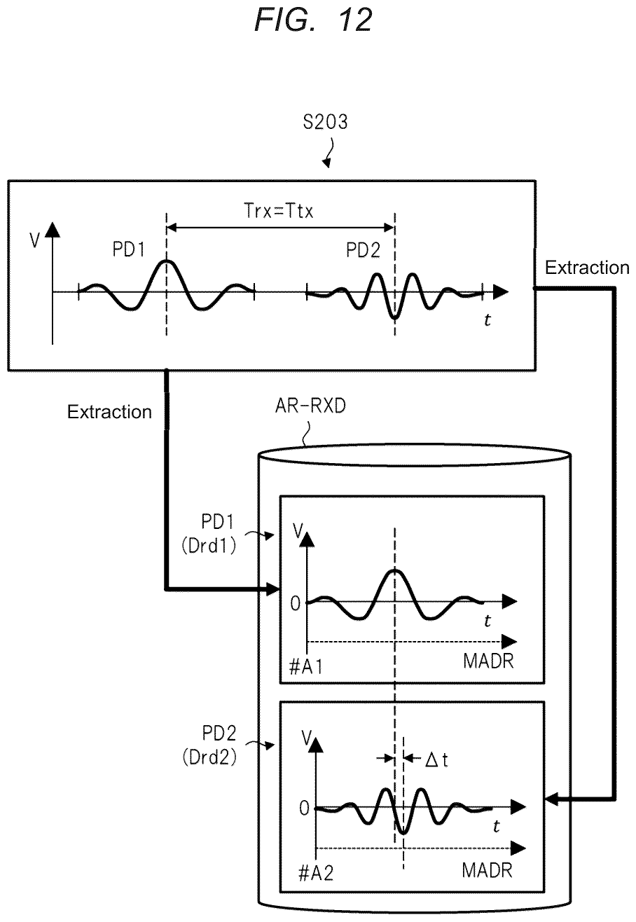

Specifically, in step S203, as shown in FIG. 12, the divided pulse signal extraction circuit PDE holds in advance the time difference determined based on the transmission interval Ttx, that is, the value of the reception interval Trx, and extracts the reception digital signals Drd1 and Drd2 corresponding to the two divided pulse signals PD1 and PD2 based on the value of the time difference. Then, the divided pulse signal extraction circuit PDE stores the extracted reception digital signals Drd1 and Drd2 as time-series data in the memory address MADR area, which is sequentially allocated from the predetermined starting addresses #A1 and #A2 in the reception data storage area AR-RXD.

However, as described in FIG. 20, the number of clock cycles representing the time difference at the transmission terminal may differ from the number of clock cycles representing the same time difference at the reception terminal. Therefore, as shown in FIG. 12, when matching the reception timing of the two reception digital signals Drd1 and Drd2 stored in the reception data storage area AR-RXD, a timing error At and consequently a shift in the memory address MADR may occur.

Therefore, in step S204 shown in FIG. 10, the time difference correction circuit TDCC corrects the time difference of the two divided pulse signals PD1 and PD2 by performing the processing described in FIG. 3 using the reception digital signals Drd1 and Drd2 stored in the reception data storage area AR-RXD. That is, the time difference correction circuit TDCC brings the timing error Δt shown in FIG. 12 closer to zero. In order to perform the processing described in FIG. 3, the divided pulse signal extraction circuit PDE extracts the divided pulse signal PD2 including the time periods before and after the predetermined time difference.

Subsequently, in step S205 shown in FIG. 10, the phase difference estimation circuit PHDE estimates the phase difference “θ1−θ2” of the two divided pulse signals PD1 and PD2 in the common frequency range 30 by performing the processing described in FIG. 5. That is, the phase difference estimation circuit PHDE estimates the phase correction amount used in the phase correction circuit PHCC. Then, the phase correction circuit PHCC corrects the phase of the two divided pulse signals PD1 and PD2 to be continuous in the common frequency range 30 based on the estimated phase difference, as shown in FIG. 4 (step S206). In the example shown in FIG. 4, the phase correction circuit PHCC corrects the phase PHr2 of the divided pulse signal PD2 to the phase PHr2c.

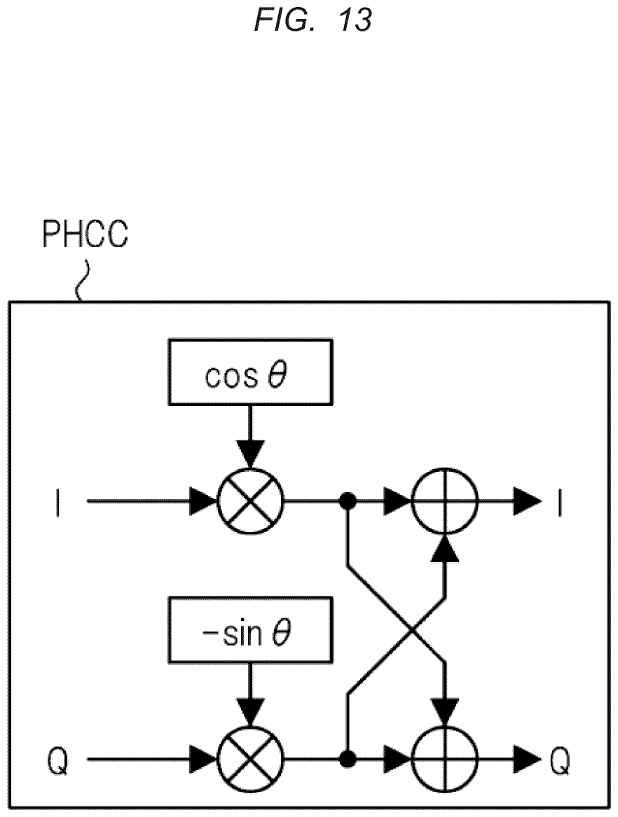

FIG. 13 is a block diagram showing a schematic configuration example of the phase correction circuit PHCC in FIG. 1. The phase correction circuit PHCC includes, for example, a digital complex mixer as shown in FIG. 13. The phase correction circuit PHCC, in outline, uses such a complex mixer to multiply the reception digital signal Drd2 corresponding to the divided pulse signal PD2 by the cosθ and sinθ components, thereby shifting the phase of the divided pulse signal PD2 by “θ”. The value of “θ” is set to the estimated phase difference value in step S205 of FIG. 10, that is, “θ1−θ2” in FIG. 5.

In detail, the phase correction circuit PHCC inputs the I signal and Q signal corresponding to the reception digital signal Drd2. The I signal and Q signal are IQ-demodulated by the mixers MIXr1 and MIXr2 shown in FIG. 1 and are signals digitized by the analog-to-digital converters ADC1 and ADC2. The phase correction circuit PHCC multiplies the I signal and Q signal by cosθ and −sinθ, respectively. Then, the phase correction circuit PHCC generates the I signal and Q signal with the phase difference corrected, that is, the reception digital signal Drd2, by adding the multiplication results “I×cosθ” and “Q×(−sinθ)”.

Next, in step S207 shown in FIG. 10, the signal restoration circuit RESC synthesizes, specifically adds, the two divided pulse signals PD1 and PD2 after the time difference correction in step S204 and the phase correction in step S206, as shown in FIG. 4, to restore the original pulse signal POrx. The restored original pulse signal POrx has a waveform shape equivalent to the original pulse signal POtx at the time of transmission.

### Modified Example

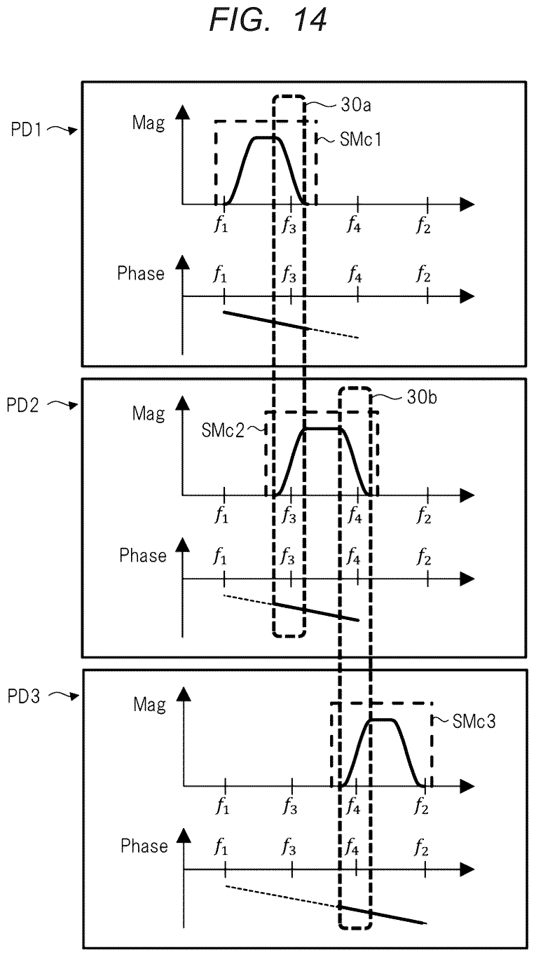

FIG. 14 is a schematic diagram explaining an example of the processing content modified from FIG. 2. In FIG. 2, the case of dividing the original pulse signal POtx into two divided pulse signals PD1 and PD2 was taken as an example, but the number of divisions may be three or more. In the example shown in FIG. 14, the transmission circuit TXC, specifically the pulse signal division circuit PLSD, divides the original pulse signal POtx, which has a frequency bandwidth from frequency f1 to frequency f2, into three divided pulse signals PD1, PD2, and PD3.

The divided pulse signals PD1 and PD2 have a common frequency range of 30a, similar to the case in FIG. 2. Similarly, the divided pulse signals PD2 and PD3 also have a common frequency range of 30b. The transmission circuit TXC sequentially transmits the three divided pulse signals PD1, PD2, and PD3 at a predetermined transmission interval Ttx, similar to the case in FIG. 8, etc. Even when using three divided pulse signals PD1, PD2, and PD3, the processing described in FIGS. 6 and 10 can be performed targeting the divided pulse signals PD2 and PD3 in addition to the divided pulse signals PD1 and PD2.

### Main Effects of the Embodiment

As described above, the semiconductor device according to one embodiment divides the original pulse signal into multiple divided pulse signals so that the common frequency ranges overlap during transmission, and then sequentially transmits them at a predetermined transmission interval. Additionally, the semiconductor device corrects the multiple divided pulse signals received with a predetermined time difference during reception as if they were received simultaneously and corrects the phase of the multiple divided pulse signals so that the phase is continuous in the common frequency range. With such a configuration, the time width of the pulse signal can be narrowed while satisfying communication standards. As a result, the accuracy of distance measurement can be improved. Furthermore, by using time difference correction and phase correction, the waveform shape of the original pulse signal at the time of transmission can be accurately restored upon reception. This allows for further improvement in ranging accuracy.

The invention made by the present inventor has been specifically described based on the embodiments, but the present invention is not limited to the above embodiments and can be variously modified without departing from the spirit thereof. For example, the aforementioned embodiments have been described in detail to clearly explain the present invention and are not necessarily limited to those including all the described configurations. It is also possible to replace part of the configuration of one embodiment with the configuration of another embodiment, and to add the configuration of another embodiment to the configuration of one embodiment. Furthermore, it is possible to add, delete, or replace parts of the configuration of each embodiment with other configurations.

Each part is typically implemented by program processing using a CPU (Central Processing Unit). That is; by executing a program stored in memory, the CPU implements each part. However, the implementation of each part is not limited to such software and may be hardware such as FPGA (Field Programmable Gate Array) or ASIC (Application Specific Integrated Circuit), or a combination of software and hardware.

The aforementioned program may be stored in a non-transitory tangible computer-readable recording medium and supplied to a computer. Such recording media include, for example, magnetic recording media represented by hard disk drives, optical recording media represented by DVDs (Digital Versatile Discs) and Blu-ray discs, and semiconductor memories represented by flash memory and SSDs (Solid State Drives).

What is claimed is:

1. A semiconductor device for UWB (Ultra-Wide Band) wireless communication implemented in a transmission terminal or a reception terminal different from the transmission terminal comprising:
a memory for storing a transmission program or a reception program;
a processor for executing the transmission program or the reception program;
a baseband circuit for processing a baseband signal;
a reference oscillation circuit for generating a reference oscillation signal;
a local oscillation circuit for generating a local signal using the reference oscillation signal; and
an analog front-end circuit for performing frequency conversion from the baseband signal to a high-frequency signal or from the high-frequency signal to the baseband signal using the local signal,
when the semiconductor device is implemented in the transmission terminal, the baseband circuit, based on the transmission program, (a) divides an original pulse signal, which becomes the baseband signal, into multiple divided pulse signals including a first divided pulse signal and a second divided pulse signal, so that each frequency bandwidth is within the frequency bandwidth defined by the UWB communication standard and overlaps a common frequency range that is part of the frequency bandwidth, (b) sequentially transmits the multiple divided pulse signals to the reception terminal via the analog front-end circuit at a first transmission interval, and when the semiconductor device is implemented in the reception terminal, the baseband circuit, based on the reception program, (c) inputs the multiple divided pulse signals sequentially received with a time difference based on the first transmission interval via the analog front-end circuit, corrects the time difference of the multiple divided pulse signals as if they were received simultaneously, (d) corrects the phase of the multiple divided pulse signals to be continuous in the common frequency range, and (e) restores the original pulse signal by adding the multiple divided pulse signals after performing the time difference correction in (c) and the phase correction in (d).

2. The semiconductor device according to claim 1,
wherein the reference oscillation circuit generates the reference oscillation signal based on the frequency of a crystal oscillator connected externally to the semiconductor device, and when the semiconductor device is implemented in the transmission terminal, the semiconductor device is connected to the crystal oscillator implemented in the transmission terminal, and when the semiconductor device is implemented in the reception terminal, the semiconductor device is connected to the crystal oscillator implemented in the reception terminal.

3. The semiconductor device according to claim 1,
the analog front-end circuit comprises a frequency conversion circuit for performing the frequency conversion, and a digital-to-analog converter or an analog-to-digital converter,
wherein when the semiconductor device is implemented in the transmission terminal, the digital-to-analog converter converts multiple transmission digital signals stored in the memory into analog signals corresponding to the multiple divided pulse signals and outputs the analog signals to the frequency conversion circuit,
wherein when the semiconductor device is implemented in the reception terminal, the analog-to-digital converter converts the multiple divided pulse signals from the frequency conversion circuit into digital signals and stores the digital signals as multiple reception digital signals in the memory.

4. The semiconductor device according to claim 3,
wherein the memory stores a first reception digital signal and a second reception digital signal corresponding to the first divided pulse signal and the second divided pulse signal, respectively, and during the time difference correction in (c), the baseband circuit calculates a correlation function between the first divided pulse signal and the second divided pulse signal when the reception timing of one of the first divided pulse signal and the second divided pulse signal is shifted, using the first reception digital signal and the second reception digital signal.

5. The semiconductor device according to claim 3,
wherein the memory stores a first reception digital signal and a second reception digital signal corresponding to the first divided pulse signal and the second divided pulse signal, respectively, and during the phase correction in (d), the baseband circuit (d1) multiplies the first divided pulse signal and the second divided pulse signal using the first reception digital signal and the second reception digital signal, and extracts a DC component from the multiplication result to estimate the phase difference between the first divided pulse signal and the second divided pulse signal in the common frequency range.

6. The semiconductor device according to claim 5,
wherein during the phase correction in (d), (d2) the baseband circuit further shifts the phase of the second divided pulse signal by θ, by using a complex mixer for multiplying the second divided pulse signal by cosθ and sinθ components, with the phase difference estimated in (d1) as θ.

7. The semiconductor device according to claim 3,
wherein during the division into the multiple divided pulse signals in (a), the baseband circuit generates a first transmission digital signal and a second transmission digital signal corresponding to the first divided pulse signal and the second divided pulse signal, respectively, using a first filter and a second filter,
wherein the first filter and the second filter have frequency characteristics that result in a predetermined gain value in a frequency band excluding the common frequency range,
wherein the first filter and the second filter have frequency characteristics that the sum of the gain values of the first filter and the second filter becomes the predetermined gain value in the common frequency range.

8. The semiconductor device according to claim 3,
wherein the memory comprises MRAM for storing the transmission program or the reception program, and a volatile memory for storing the multiple transmission digital signals or the multiple reception digital signals.

9. A semiconductor device for UWB (Ultra-Wide Band) wireless communication comprising:
a memory;
a baseband circuit for processing baseband signals;
a reference oscillation circuit for generating a reference oscillation signal;
a local oscillation circuit for generating a local signal using the reference oscillation signal; and
an analog front-end circuit for frequency conversion from the baseband signal to a high-frequency signal or from the high-frequency signal to the baseband signal using the local signal,
wherein the baseband circuit as transmission circuit includes a pulse signal division circuit that divides the original pulse signal, which becomes the baseband signal, into multiple divided pulse signals including a first divided pulse signal and a second divided pulse signal, so that each frequency bandwidth falls within the frequency bandwidth range specified by the UWB communication standard and overlaps a common frequency range that is part of the frequency bandwidth, and a data transfer circuit that sequentially transmits the multiple divided pulse signals at a first transmission interval via the analog front-end circuit as a receiving circuit,
wherein the baseband circuit as reception circuit includes a time difference correction circuit that inputs the multiple divided pulse signals sequentially received with a time difference based on the first transmission interval via the analog front-end circuit and corrects the time difference of the multiple divided pulse signals as if they were received simultaneously, a phase correction circuit that corrects the phase of the multiple divided pulse signals to be continuous in the common frequency range, and a signal restoration circuit that restores the original pulse signal by adding the multiple divided pulse signals after time difference correction by the time difference correction circuit and phase correction by the phase correction circuit.

10. The semiconductor device according to claim 9,
the analog includes a frequency front-end circuit conversion circuit for performing the frequency conversion, a digital-to-analog converter as the transmission circuit, and an analog-to-digital converter as the receiving circuit,
wherein the digital-to-analog converter corresponds to digital signals for each of the multiple divided pulse signals, converts multiple transmission digital signals stored in the memory into analog signals, and outputs them to the frequency conversion circuit,
wherein the analog-to-digital converter converts the multiple divided pulse signals from the frequency conversion circuit into digital signals and stores them as multiple reception digital signals in the memory.

11. The semiconductor device according to claim 10,
wherein the memory stores a first reception digital signal and a second reception digital signal corresponding to the first divided pulse signal and the second divided pulse signal, respectively,
wherein the time difference correction circuit calculates the correlation function between the first divided pulse signal and the second divided pulse signal when the reception timing of one of the first divided pulse signal and the second divided pulse signal is shifted, using the first reception digital signal and the second reception digital signal.

12. The semiconductor device according to claim 10, further comprising a phase difference estimation circuit for estimating the correction amount of the phase used in the phase correction circuit,
wherein the memory stores a first reception digital signal and a second reception digital signal corresponding to the first divided pulse signal and the second divided pulse signal, respectively,
wherein the phase difference estimation circuit multiplies the first divided pulse signal and the second divided pulse signal using the first reception digital signal and the second reception digital signal and extracts the DC component from the multiplication result to estimate the phase difference between the first divided pulse signal and the second divided pulse signal in the common frequency range.
